(19) United States
(12) Patent Application Publication
(10) Pub. No.: US 2015/0043204 A1
(43) Pub. Date: Feb. 12, 2015

(54) Profile Arrangement for Room Lighting

(71) Applicant: PAULMANN LICHT GMBH, Springe-Volksen (DE)

(72) Inventors: Kristina Hahn, Springe-Volksen (DE); Carsten Weinsziehr, Springe-Volksen (DE); Gerald Giese, Springe-Volksen (DE); Detlev Paulmann, Springe-Volksen (DE)

(21) Appl. No.: 14/378,253

(22) PCT Filed: Mar. 15, 2013
(86) PCT No.: PCT/EP2013/055350

§ 371 Date: Oct. 27, 2014

(30) Foreign Application Priority Data
Mar. 15, 2012 (DE) 202012002594.5

(51) Int. Cl. F21K 99/00; F21V 21/02; F21V 3/02; F21S 8/00

(52) U.S. Cl. CPC F21K 9/175; F21S 8/03; F21V 21/02; F21V 3/02; F21Y 2103/003
USPC 362/219

(57) ABSTRACT

A profile arrangement for room lighting is described comprising a light bar (2), which shows an oblong, essentially impermeable revetment leg (4) and an oblong spacer leg (6), with at one of its long sides the revetment leg (4) being arranged with its long side and at an angle, preferably a right angle, and with lighting means (9a) positioned approximately in a line, which are arranged at an interior (4a) of the revetment leg (4) facing the spacer leg (6) and/or at a side of the spacer leg (6) adjacent to the revetment leg (4), with the spacer leg (6) being provided with means (6a, 8) for fastening at least at one section of at least one base (10) to be mounted to a wall and/or ceiling of a room, here yielding a distance of the revetment leg (4) from at least one base (10).

The invention relates to the profile arrangement for room lighting comprising a light bar and lighting means provided at said light bar, positioned approximately in a line.

An arrangement of lighting means, positioned approximately in a line at a light bar or light rail is known from prior art. For this purpose, reference is made to DE 20 212 485 U1 for example, which discloses a lighting means with a light-permeable tube embodied as a closed profile, with light diodes being assembled inside thereof on a base board, on a bar-shaped fastening arranged in the longitudinal extension of the tube.

According to the invention now a profile arrangement for room lighting is suggested comprising a light bar, which shows an oblong, essentially impermeable revetment leg and an oblong spacer leg, with at a long side of the spacer leg the revetment leg being arranged with one of its long sides in an angled fashion, preferably at a right angle, and with lighting means positioned approximately in a line, which are arranged at an inside of the revetment leg facing the spacer leg and/or at a side of the spacer leg adjacent to the revetment leg, with the spacer leg being provided with means for fastening at least at one base to be mounted at a section of a wall and/or a ceiling of a room, here yielding a distance of the revetment leg from at least one base.

With the help of the invention indirect room lighting is realized in a simply constructed, yet effective way using lighting means located in a line. The construction according to the invention is particularly suited for the application of strips of light diodes, which are widely available in the market by now. Due to the fact that the light bar is intended for a surface assembly using a base and the lighting means arranged in a line are provided at the inside of the revetment leg and/or at a side of the spacer leg adjacent to the revetment leg, here a pleasant indirect room lighting results. The profile arrangement for room lighting according to the invention can be fastened along a wall or ceiling or at vertical or horizontal corners of the room. The construction according to the invention further allows in a simply designed, yet effective fashion the construction of a component or modular system, simplifying both the production as well as the assembly, because here only a manageable number of different components need to be produced and an uncomplicated placement of the profile arrangement for room lighting is possible by a mere sequencing of the components or modules. Thus the profile arrangement for room lighting according to the invention primarily targets the private consumer, who due to the simple construction is enabled to fasten such a profile arrangement for room lighting without any problems in the do-it-yourself method.

Here the revetment legs and/or the spacer leg serve not only as the carriers for the serial arrangement of the lighting means, but the design according to the invention also allows a clever storage of electric supply lines such that they are hidden by the revetment leg; in order to fixate electric supply lines here similarly the base can be used, the spacer leg, or the interior of the revetment leg.

Finally, the light bar and particularly the exterior of its revetment leg can also be used beneficially for decorative purposes.

Preferred embodiments and further developments of the invention are disclosed in the dependent claims.

For example, in a preferred embodiment of the invention the revetment leg is arranged on the spacer leg at a location between the two long sides and thus extends at both sides of said spacer leg. In a further development of this embodiment the revetment leg is arranged centrally on the spacer leg. Accordingly, the structural unit comprising the revetment leg and the spacer leg shows in its cross-section a “T”-form.

Beneficially the spacer leg shows two engagement sections, distanced from each other and preferably showing the form of bands or strips, with for the purpose of fastening, the spacer leg at the base can be made to contact or engage said section at a rack-like section embodied at the base, preferably in the form of a clamping engagement. Alternatively an inverse arrangement is also possible, in which the base is provided with the two engagement sections, which can be made to contact or engage said section at a rack-like section of the spacer leg, preferably in a clamping fashion. Preferably here the engagement sections extend approximately parallel in reference to each other. Preferably the two engagement sections are embodied for accepting the rack-like section between each other and preferably for an essentially planar contact at the rack-like section, allowing the rack-like section to be inserted between the two engagement sections. For this purpose, the bar-like section may show two wall sections, distanced from each other and extending preferably approximately parallel in reference to each other.

In another further development of the above-mentioned embodiment the engagement sections are provided with first locking means for a detachable locking engagement with the two locking means provided at the rack-like section. For example, the two engagement sections, distanced from each other, may be embodied such that for the assembly they accept and/or encompass the rack-like section between each other, and in order to achieve a clamping engagement they are pre-stressed towards each other. In general, of course other embodiments and fastening options are also possible. For example, the rack-like section may also be hollow and open at its face, so that the engagement sections can be inserted therein, with the engagement sections in this variant being pre-stressed elastically outwardly in order to achieve a clamping engagement with the interior walls of the hollow rack-like section.

According to another preferred embodiment, at least one plate-like, light-permeable cover can be fastened at the revetment leg and arranged in the direction towards the base. Such a light-permeable cover, which may be made from an acrylic disk for example, is particularly advantageous in that it offers an effective dust protection and simultaneously can be used for a targeted disbursement of the light generated by the lighting means.

In a further development of the above-mentioned embodiment here the light-permeable cover can be fastened at least at one long side of the revetment leg. For this purpose, for a particularly simple and yet effective fastening a groove may be embodied at the side of the revetment leg facing the spacer leg, extending in the longitudinal direction of the revetment leg, into which the light-permeable cover can be inserted with its adjacent edge. Further, beneficially the light permeable cover may extend approximately parallel in reference to the spacer leg. Alternatively or additionally, the light-permeable cover may also be anchored at the base for fastening at the revetment leg.

In another preferred embodiment the base comprises a base plate for the assembly at least at one section of a wall and/or ceiling of a room, in order to securely fasten the profile arrangement for room lighting. In case of an anchoring at the base it should preferably be possible to fasten the light-permeable cover at said base plate.

For the assembly on an essentially planar surface of a wall or ceiling of a room the base plate should be provided with an essentially planar assembly area.

For the fastening in the corner area of two adjacent walls of the room or between a wall of the room and the ceiling the base should preferably show two angled sections, extending parallel in reference to each other, for a joint fastening at the respectively angled, adjacent sections of a wall and/or ceiling of a room.

Alternatively thereto, it is also possible to provide a base adapter, which is embodied for fastening at the base and comprises two angled sections, extending parallel in reference to each other, for a joint fastening of the base adapter with the base fastened thereon at two appropriately angled, adjacent sections of two adjacent walls of a room or a wall and a ceiling of a room.

In order to fasten electric supply lines and/or connections to the lighting means beneficially the base is provided with appropriate fastening means. Thus, in this embodiment the electric supply lines are guided along the bases. Preferably the fastening means are provided at a base plate and/or show clamping means.

In another advantageous embodiment the lighting means are arranged on a strip, with its back being equipped with an adhesive tape. Here, preferably light diode strips are suitable, which are available in a prefabricated fashion, with the strips being equipped at their back with an adhesive tape and are adhered to the intended areas.

In the following, preferred exemplary embodiments of the invention are explained in greater detail based on the attached drawings. It shows:

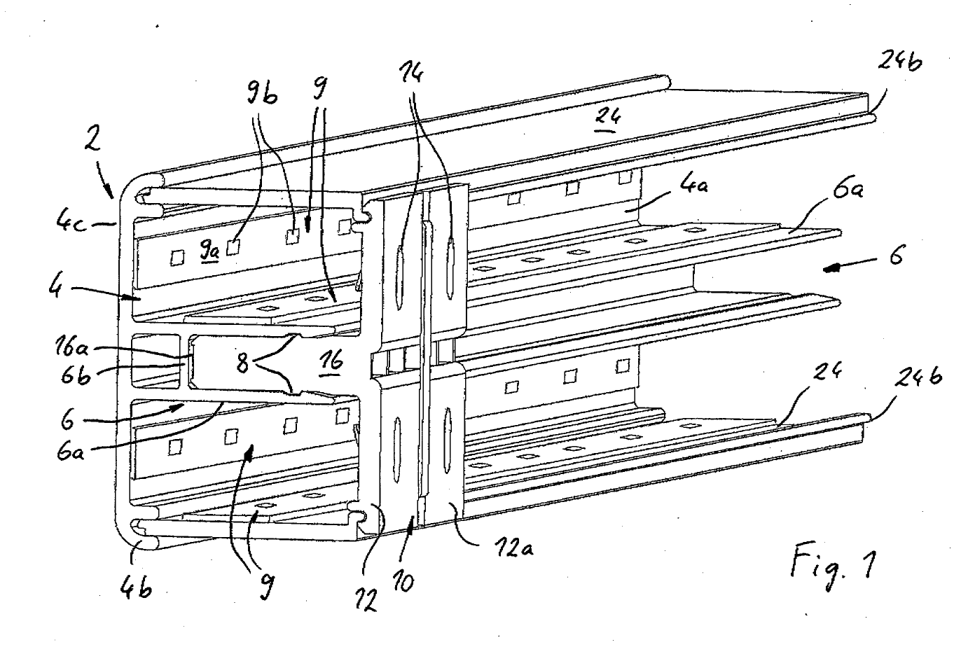

FIG. 1 in a perspective view from the bottom, a profile arrangement for room lighting according to a first preferred embodiment of the invention in the assembled state;

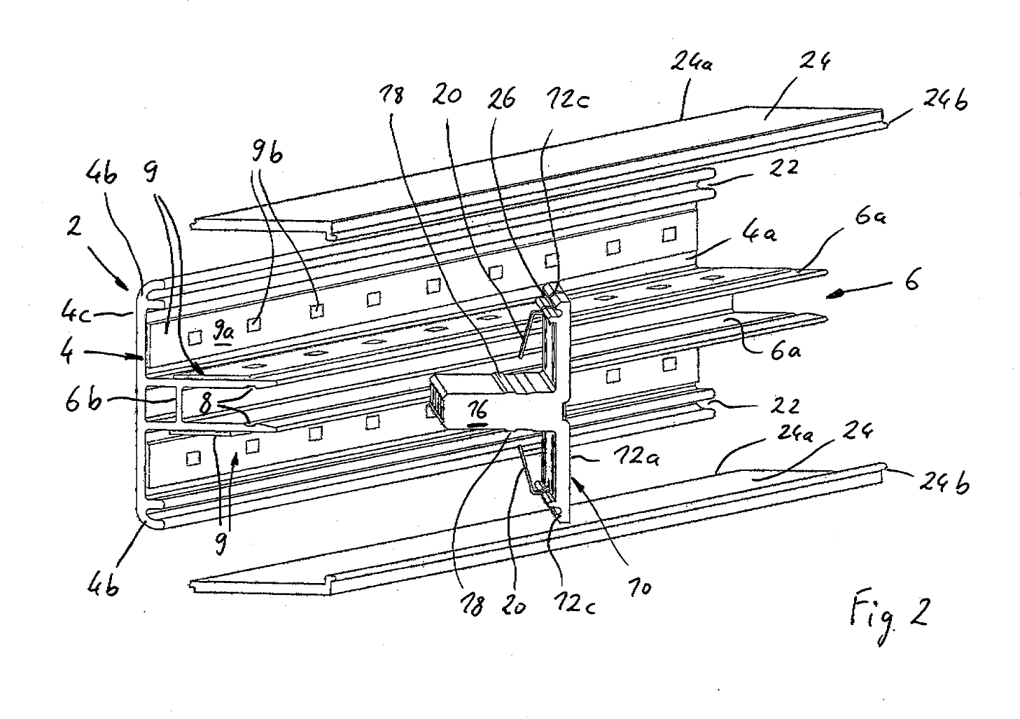

FIG. 2 a perspective view of the profile arrangement for room lighting of FIG. 1 from the bottom in an exploded illustration;

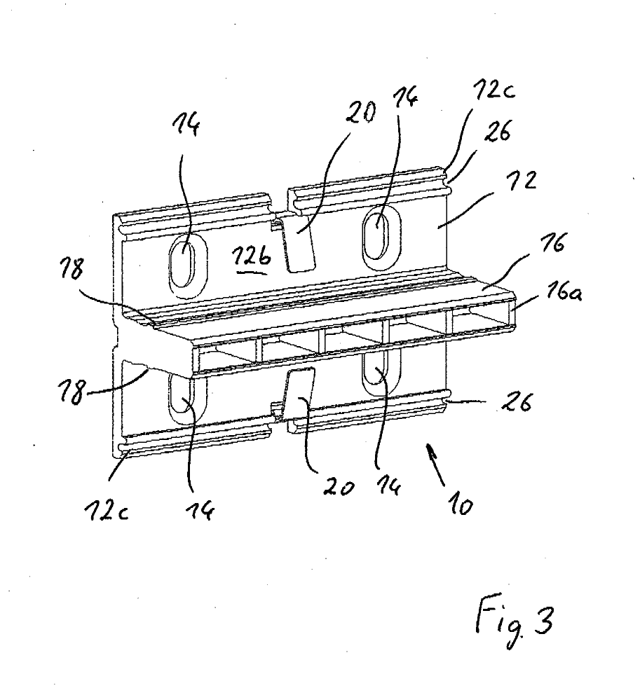

FIG. 3 in a perspective detail, a base for the profile arrangement for room lighting of FIG. 1;

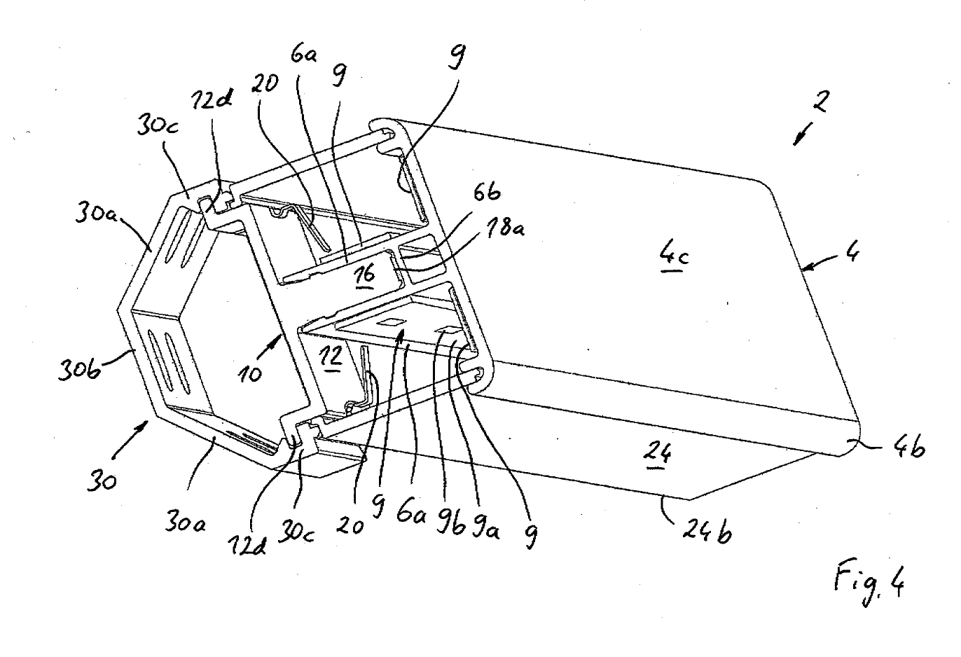

FIG. 4 in a perspective view from the top, a profile arrangement for room lighting according to a second preferred embodiment of the invention in the assembled state;

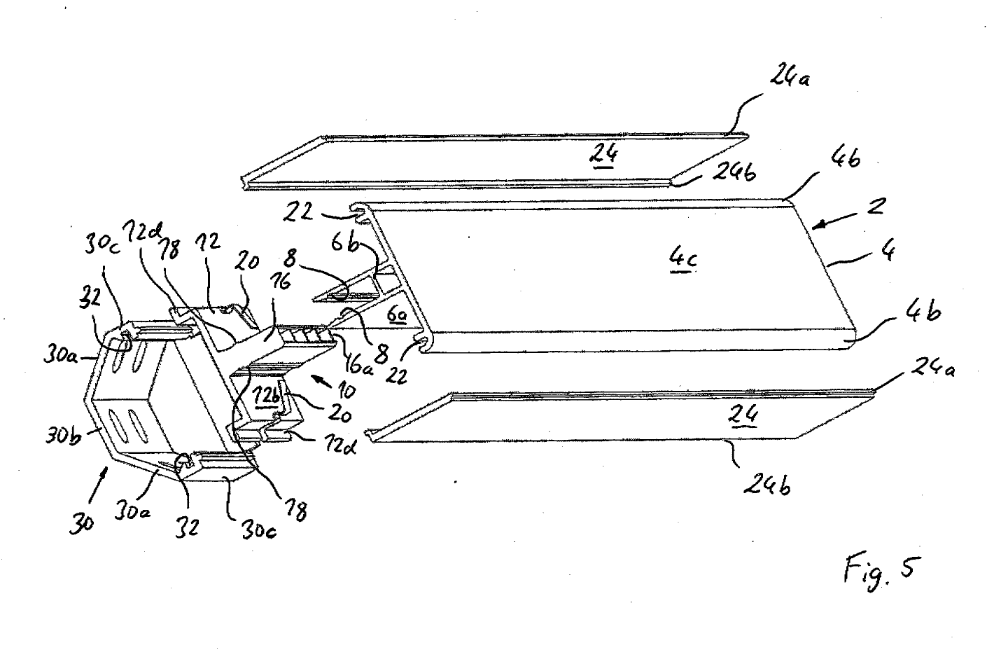

FIG. 5 a perspective view of the profile arrangement for room lighting of FIG. 4 from the top in an exploded illustration;

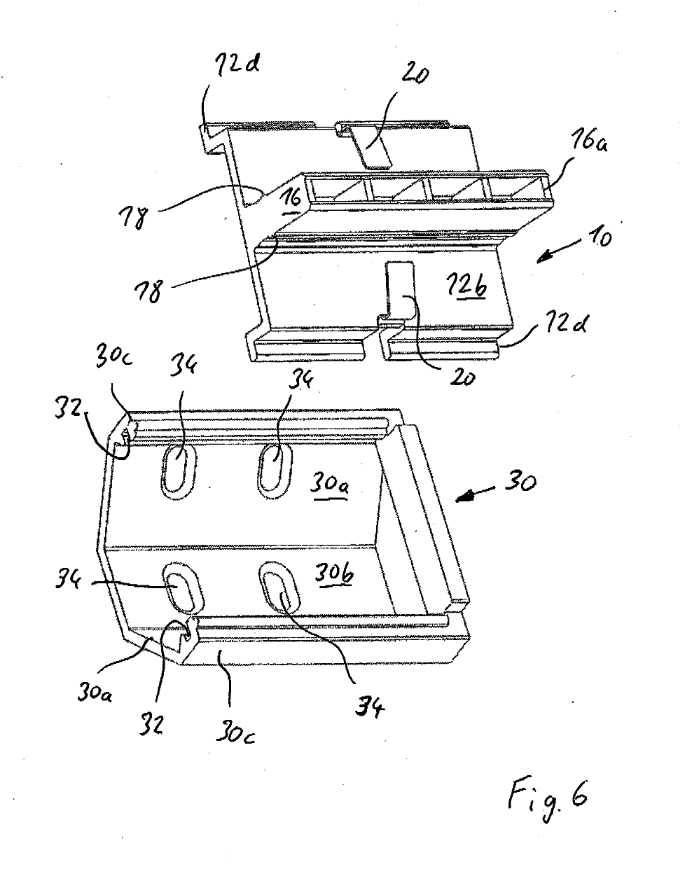

FIG. 6 in a perspective detail, a base and a base adapter for the profile arrangement for room lighting of FIG. 4; and

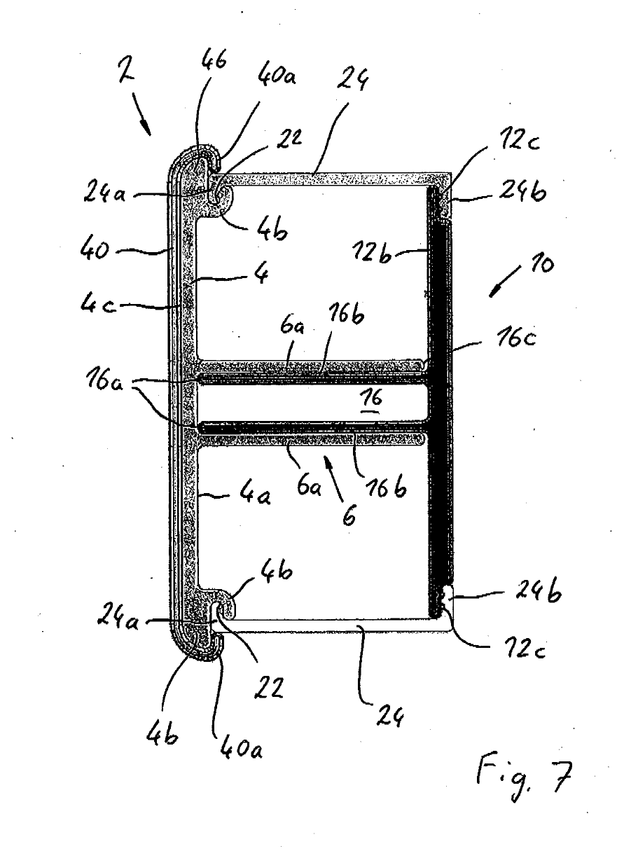

FIG. 7 in a cross-section, a profile arrangement for room lighting according to a third preferred embodiment of the invention in the assembled state.

With reference to FIGS. 1 to 3, in the following a profile arrangement for room lighting according to a first exemplary embodiment is explained.

A light bar 2 is a component of the profile arrangement for room lighting, showing a revetment leg 4 and a spacer leg 6, arranged at the revetment leg at its interior 4a at a right angle. As discernible from FIGS. 1 and 2, the revetment leg 4 is positioned centrally on the spacer leg 6, resulting in the light bar 2 showing a T-shaped cross-section. In the exemplary embodiment shown the revetment leg 4 and the spacer leg 6 are connected to each other in one piece and thus a light bar 2 is yielded in one piece, which is preferably made from plastic. As further discernible from FIGS. 1 and 2, the spacer leg 6 shows two plate-shaped engagement sections 6a, distanced from each other and extending parallel in reference to each other, which are arranged at a right in reference to the revetment leg 4 and in the exemplary embodiment they are provided at their opposite interior areas with a locking groove 8, which extends in the longitudinal direction of the light bar 2. By the plate-shaped engagement sections 6a, distanced from each other, the spacer leg 6 is open at its face.

The light bar 2 is provided for accepting lighting means such that the lighting means are hidden by the revetment leg 4. For this purpose, a linear arrangement of lighting means is used, which are fastened at the interior 4a of the revetment leg 4 and/or at one or both exterior areas of the spacer leg 6. Here preferably lighting means are used, which are arranged on a strip, with its back being provided with an adhesive tape. Here, preferably light diode strips are suitable, as used in the exemplary embodiment shown. The light diode strips 9 discernible in FIGS. 1 and 2 respectively show a strip-like body 9a, on which light diodes 9b are fastened in a linear arrangement, with the strips being equipped at their back with adhesive tape and adhered to the intended areas.

In order for the revetment leg 4 to fulfill its concealing function and thus allowing the light bar 2 to generate indirect room lighting, the revetment leg 4 is essentially made from an opaque material or is produced from such a material at least at its exterior 4c. In this context it shall also be mentioned that the light bar 2 and particularly the exterior 4c of the revetment leg 4 can also be used for decorative purposes, if necessary, by for example providing the exterior 4c of the revetment leg 4 with a respective decoration or applying it upon the exterior 4c.

A base 10 is provided for fastening at least at a section of a wall and/or ceiling of a room, not shown in the figures, which in the illustrated exemplary embodiment according to FIGS. 1 to 3 comprises a planar base plate 12 with a planar exterior and/or bottom side 12a, which forms a planar assembly area for fastening at the wall or ceiling of the room. In the exemplary embodiment shown the fastening of the base 10 at the wall or ceiling of the room occurs with the help of screws, not shown, with here respective penetrating openings 14 being provided in the base plate 12. A rack 16 protrudes from the interior 12b of the base plate 12 at a right angle, with an oblong locking projection 18 being formed at its two lateral walls, extending in the longitudinal direction of the light bar 2, as particularly discernible from FIG. 3 in connection with FIG. 1. As further discernible from FIG. 1, the light bar 2 with its spacer leg 6 is plugged onto the rack 16 of the base 10 for fastening on said base 10, with in the exemplary embodiment shown the two engagement sections 6a of the spacer leg 6 accepting the rack 16 of the base 10 between each other. Here, the locking projections 18 at the rack 16 engage via the locking grooves 8 the interior area of the engagement sections 6a of the spacer leg 6. In order for such a locking to be successful the locking grooves 8 and the locking projections 18 must be appropriately aligned to each other. Additionally, for such a secure locking the engagement sections 6a of the spacer leg 6 shall contact at the exterior of the rack 16 of the base 10. For this purpose, the engagement sections 6a of the spacer leg 6 are elastically pre-stressed towards each other. In order to form a defined distance between the revetment leg 4 and the base 10 and thus a defined height of the light bar 2 in reference to the wall or ceiling of the room, the cavity formed between the two distanced plate-shaped engagement sections 6a is limited in its depth by a crossbar 6b in the spacer leg 6, contacted in the assembled state by the rack 16 of the base 10 with the top and/or face 16a at its free end such that the crossbar 6b serves as a stop in the spacer leg 6.

As particularly discernible from FIGS. 2 and 3, clamps 10 are provided at the interior 12b of the base plate 12 of the base 10 for fastening electric supply lines and/or connection means, not shown in the figures, which can be laid therefore along the base 10 in the longitudinal extension of the light bar 2.

Several such bases 10 are used for a secure assembly of the light bar 2, which are fastened serially at a distance from each other at the wall or ceiling of the room such that their racks 16 are positioned in a line. Alternatively it is also possible, contrary to the illustration in FIGS. 1 to 3, to embody the base 10 as an oblong band or rail according to the length of the light bar 2.

As further discernible from FIGS. 1 and 2, the revetment leg 4 of the light bar 2 is provided along its two long sides with beveled and/or curved longitudinal edges 4b extending in the direction of the spacer leg 6 and/or the direction of the base 10, with in the exemplary embodiment shown respectively one groove 22 (FIG. 2) is integrated in the direction of the longitudinal extension of the light bar 2. This groove 22 serves for fastening a light-permeable cover 24, with its longitudinal edge 24a being inserted into the groove 22, as discernible from FIG. 2 in connection with FIG. 1. Additionally, the light-permeable cover 24 is also fixed at the base 10, by engaging with its other, opposite longitudinal edge 24b a groove 26, embodied along the lateral edge 12c of the base plate 12 of the base 10 in the exemplary embodiment shown, as discernible from FIG. 1 in connection with FIG. 3. In the exemplary embodiment shown, at both sides of the light bar 2 respectively one light-permeable cover 24 is arranged. This way an essentially closed body is formed, with the light-permeable covers 24, primarily serving for light disbursements, additionally performing the function of dust protection. As discernible from FIGS. 1 and 2, the light-permeable covers 24 form essentially a rectangular plate in the exemplary embodiment shown. Preferably, the light-permeable cover 24 is made from an acrylic disk.

Alternatively it is also possible, contrary to the exemplary embodiment shown, to omit the light-permeable cover 24 and to lay the light bar 2 without it.

FIGS. 4 to 6 show a profile arrangement for room lighting according to a second exemplary embodiment, which differs from the first exemplary embodiment according to FIGS. 1 to 3 such that here the laying is possible along a corner of the room, thus a corner between two walls of the room or between a wall and a ceiling of the room. For this purpose, the base 10 is not fastened directly at a wall or ceiling of the room but is fastened on a base adapter 30, which is mounted in the corner of the room and thus is interposed between the base 10 and the corner of the room, not shown in the figures. The base adapter 30 comprises two exterior sections 30a, aligned at a right angle in reference to each other, and a central section 30b, connecting these two sections 30a with each other. For the purpose of fastening at the base adapter 30 here the base 10 is slightly modified in reference to the exemplary embodiment according to FIGS. 1 to 3, by its lateral edges 12d not showing a groove, but being provided with a rack-like projection, which in the assembled state engages a corresponding groove 32, which is respectively formed along the opposite lateral edge 30c of the base adapter 30. The fastening of the base adapter 30 at the abutting sections of two neighboring walls of the room or a wall and the ceiling of the room occurs preferably via screws, which are inserted into penetrating openings 34 (FIG. 6) embodied in the base adapter 30. After the finished assembly, the base adapter 30 abuts with its two sections 30a, forming a right angle, the neighboring walls of the room and/or the room and the neighboring ceiling, so that their exterior sides form the assembly area, which is not shown in the figures, though.

The other components shown in FIGS. 4 to 6 are equivalent to the components shown in FIGS. 1 to 3, so that in order to avoid repetitions reference is made to the above-stated explanations of these components in the context with the description of the first embodiment based on FIGS. 1 to 3, with for reasons of better visibility the light diode strips 9 are omitted in FIG. 5.

From the above-made statements it is discernible that the base 10 and the base adapter 30 form a joint base assembly in the second exemplary embodiment according to FIGS. 4 to 6, in order to fasten the light bar 2 in a secure and simultaneously clever fashion at a corner of a room. Alternatively it is also possible to form the base 10 and the base adapter 30 jointly as a one-piece base.

In FIG. 7 a profile arrangement for room lighting is shown according to a third exemplary embodiment in a cross-section, which differs from the first exemplary embodiment according to FIGS. 1 to 3 such that no engagement occurs between the spacer leg 6 and the rack 16 of the base 10. This way, the spacer legs 6, the locking grooves 8, and the locking projections 18 at the rack 16 are missing, which are present in the first embodiment according to FIGS. 1 to 3. Rather, in the third exemplary embodiment according to FIG. 7 the rack 16 of the base 10 shows two plate-shaped wall sections 16b, distanced from each other and extending parallel, with their exterior respectively contacting one of the engagement sections 6a each of the spacer leg 6 essentially in a planar fashion. Unlike the first exemplary embodiment, the engagement sections 6a and the wall sections 16b show essentially the same height, so that in the assembled state the wall sections 16b of the rack 16 with the face 16a of their free end contact the interior 4a of the revetment leg 4 and the engagement sections 6a of the spacer leg 6 with the face 16c of their free end contact the interior 12b of the base plate 12 of the base 10. Due to the fact that the anchoring of the revetment leg 4 at the leg 10 in the third exemplary embodiment according to FIG. 7 does not occur via the spacer leg 6 and the rack 16 of the base 10, the anchoring is performed by the light-permeable covers 24 provided at both sides. For this purpose, the groove 22 is open in the two longitudinal edges 4b of the revetment leg 4 not in the direction towards the base 10, but towards the side engaged by the longitudinal edge 24a of the light-permeable cover 24, with said longitudinal edge 24a being embodied at a right angle in reference to the remaining cover 24 and thus forming an L. Additionally, unlike the first exemplary embodiment according to FIGS. 1 to 3, the other longitudinal edge 24b is also embodied at a right angle in reference to the remaining cover 24 and thus shows a L-form, so that in the assembled state it engages under the lateral edge 12c of the base plate 12 of the base 10, as discernible from FIG. 7. Thus, the light-permeable covers 24 serve for anchoring the revetment leg 4 and thus the light bar 2 at the base 10.

Even if the third exemplary embodiment shown in FIG. 7 primarily represents a modification of the first exemplary embodiment according to FIGS. 1 to 3, the above-described anchoring principle of the third exemplary embodiment can generally also be realized in the second exemplary embodiment according to FIGS. 4 to 6 by way of an appropriate design modification.

Contrary to FIGS. 1 to 6, FIG. 7 further discloses a decorative blind 40, which covers the exterior 4c of the revetment leg 4 and with its curved and/or beveled longitudinal edges 40a encompassing the revetment leg 4 at its longitudinal edges 4b. In the same fashion, however, the fastening of such a decorative blind 40 can be implemented at the first exemplary embodiment according to FIGS. 1 to 3 as well as at the second exemplary embodiment according to FIGS. 4 to 6.

The other components shown in FIG. 7 are equivalent to the components shown in FIGS. 1 to 3 so that in order to avoid repetitions, reference is made to the above-made explanations of these components in the context with the description of the first embodiment based on FIGS. 1 to 3. However, for reasons of better visibility an illustration of the light diode strip 9, shown in FIGS. 1 and 2, is waived, however they are used in the third exemplary embodiment according to FIG. 7 in a similar arrangement as in the first exemplary embodiment.

1. A profile arrangement for room lighting with a light bar (2), which shows an oblong, essentially impermeable revetment leg (4) and an oblong spacer leg (6), with at one of its long sides the revetment leg (4) is arranged with one of its long sides at an angle, preferably a right angle, and with lighting means (9a) positioned approximately in a line, which are arranged at an interior (4a) of the revetment leg (4) aligned towards the spacer leg (6) and/or at a side of the spacer leg (6) adjacent to the revetment leg (4), with the spacer leg (6) showing means (6a, 8) for fastening at least at one base (10) to be assembled at a section of a wall and/or ceiling of a room generating a distance of the revetment leg (4) from at least one base (10).

2. An arrangement according to claim 1, in which the revetment leg (4) is arranged at a position between its two longitudinal sides (4b) on the spacer leg (6) and thus extends at both sides of the spacer leg (6).

3. An arrangement according to claim 1 or 2, in which the revetment leg (4) is arranged approximately centrally on the spacer leg (6).

4. An arrangement according to at least one of the previous claims, in which the spacer leg (6) engages two engagement sections (6a), distanced from each other and preferably showing the form of bands or strips, which for the purpose of fastening the spacer leg (6) at the base (10) contact a rack-like section (16) embodied at the base (10) or can be made to engage said section (16), or shows a rack-like section, which can be made to contact two engagement sections, embodied at the base and distanced from each other, preferably in the form of bands or strips or can be made to engage these engagement sections.

5. An arrangement according to claim 4, in which the two engagement sections are embodied to accept the rack-like section between each other and preferably are embodied for an essentially planar contact at the rack-like section.

6. An arrangement according to claim 4 or 5, in which the rack-like section shows two wall sections, distanced from each other and extending preferably approximately parallel.

7. An arrangement according to at least one of claims 4 to 6, in which the engagement sections (6a) are provided with first locking means (8) for a detachable, locking engagement with two locking means (18) embodied at the rack-like section (16).

8. An arrangement according to at least one of claims 4 to 7, in which the engagement sections (6a) extend approximately parallel in reference to each other.

9. An arrangement according to at least one of the previous claims, with at least one plate-shaped, light-permeable cover (24), which can be fastened at the revetment leg (4) and arranged in the direction towards the base (10).

10. An arrangement according to claim 9, in which the light permeable cover (24) can be fastened at least at one long side (4b) of the revetment leg (4).

11. An arrangement according to claim 9 or 10, in which at the side (4a) of the revetment leg (4) facing the spacer leg (6) a groove (22) is formed, extending in the longitudinal direction of the revetment leg (4), into which the light permeable cover (24) can be inserted with its adjacent edge (24a).

12. An arrangement according to at least one of claims 9 to 11, in which the light permeable cover (24) extends approximately parallel to the spacer leg (6).

13. An arrangement according to at least one of claims 9 to 12, in which the light permeable cover (24) can be anchored at the base (10).

14. An arrangement according to at least one of the previous claims, comprising a base (10), showing a base plate (12) to be assembled at least at one section of a wall and/or ceiling of a room.

15. An arrangement according to claims 13 and 14, in which the light permeable cover (24) can be anchored at the base plate (12).

16. An arrangement according to claim 14 or 15, in which the base plate (12) comprises an essentially planar assembly area (12a) for fastening at least at one section of a wall or ceiling of a room.

17. An arrangement according to claim 14 or 15, in which the base shows two angular sections extending parallel in reference to each other for a joint fastening at two sections of a wall and/or ceiling of a room, forming an angle.

18. An arrangement according to at least one of claims 1 to 16, with a base adapter (30), embodied for fastening at the base (10), and two angled sections (30a), extending parallel in reference to each other, for a joint fastening of the base adapter (30) at two correspondingly angled sections of a wall and/or ceiling of a room.

19. An arrangement according to at least one of the previous claims, in which the base (10) shows fastening means (20) for the fastening of electric supply lines and/or connections to the lighting means (9a).

20. An arrangement according to claims 14 and 19, in which the fastening means (20) are provided at the base plate (12).

21. An arrangement according to claim 19 or 20, in which the fastening means (20) show clamping means.

22. An arrangement according to at least one of the previous claims, in which the lighting means (9a) are arranged on a strip-like body (9b), equipped with an adhesive tape on its back.
